(19) United States
(12) Patent Application Publication
(10) Pub. No.: US 2006/0026240 A1
(43) Pub. Date: Feb. 2, 2006

(54) Method of collecting data from one or multiple respondents using spreadsheet based tool with programmed wizard utility deployed by e-mail

(75) Inventors: Cece Anthony, West Orange, NJ (US); Tam Trinh, Secaucus, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 10/901,283

(22) Filed: Jul. 28, 2004

(51) Int. Cl. G06F 15/16

(52) U.S. Cl. 709/206

(57) ABSTRACT

The invention discloses a method of collecting data from one or multiple respondents comprising creating a questionnaire using an easy-to-use wizard utility within a spreadsheet application operating a series of macros; deploying said questionnaire by e-mail; and retrieving data from an e-mail attachment (containing the filled out questionnaire) returned by respondent or respondents.

### FIELD OF THE INVENTION

The present invention relates to collection of data (e.g., in the form of a survey or questionnaire) from one or multiple respondents using a tool which allows the collector of information to easily prepare, disseminate and collect such information. An administrator with no knowledge of programming can prepare the data collection document (e.g., questionnaire) using a “wizard” utility within a spreadsheet application to operate macros (list of commands within the utility) easily creating the document and no software installation is required.

### BACKGROUND

In order to maintain competitive, consumer good companies, as well as others, have an ever increasing need to gather information and data from consumers quickly and accurately. This has created a need for conducting larger and more complex clinical and consumer studies as well as a need to turn over results in a short time frame. One of the many challenges that arise with the increase in study size is the collection, management, cleansing and merging of data.

Historically data has been collected through the use of questionnaires either created using a word processing utility and filled out by hand or through the use of scannable forms. Each method has its drawbacks, some of which include transcription errors, missing data and inconsistency of data coding. In addition there can be a significant lag time between the actual collection of the data and the time at which the data is ready for analysis. Often the data is hand transcribed from individual questionnaires into a spreadsheet. Cleansing and restructuring of data often is done manually as well.

Data collection through electronic means is conducted routinely over the Internet. These web-based systems typically require a web server, a database server, and server and client side survey creation and publishing tools. While this form of electronic data collection can reach a large population, there is significant overhead in the cost and maintenance of hardware and software.

Questionnaires have been used where data is collected by e-mail and/or where people fill in information on a computer which is part of a network and data is sent to a networked filed.

While these systems have been useful for saving time and improving the quality of data, the creation of new questionnaires requires the skill of someone knowledgeable, for example, in Visual Basic for Applications (VBA) programming.

According to the subject invention, applicants have devised a method wherein a spreadsheet program or application is equipped with a wizard (defined as a utility within an application helping the user perform a given task) which allows the data collecting administrator to easily create a document (e.g., questionnaire), even though the administrator has no experience in programming, and requiring only access to the spreadsheet program containing said wizard. Further, no software installation is required. The document can then be readily deployed (e.g., by e-mail, or activation on one or more personal computers), and readily retrieved (e.g., imported to spreadsheet).

U.S. Pat. No. 5,893,098 to Peters et al. discloses a system and method for obtaining and collecting survey information from a plurality of computer users.

While the reference refers to creation of a document, it does not appear to teach or disclose use of spreadsheet program containing a wizard utility which can be used to readily create a document, which document is then readily deployed and from which data is subsequently retrieved.

U.S. Patent Application Publication No. 2002/0007303 A1 discloses a system for conducting electronic surveys, but again does not disclose or suggest a method of collecting data using a spreadsheet based tool having an easy to use, programmed wizard utility.

### BRIEF DESCRIPTION OF THE INVENTION

The present invention provides a method for collecting data from one or multiple respondents (e.g., who have visited a site and participated in a study) wherein the method comprises (1) creating a questionnaire for the respondent(s) wherein the questionnaire is created from a wizard utility within a spreadsheet application (e.g. Excel® spreadsheet application) which controls a series of macros; (2) deploying the questionnaire (e.g., in one embodiment by e-mail; and in another by activating a computer or computers for direct data entry); and (3) retrieving data, depending on method of deployment. Each of these steps is described in more detail below.

These and other aspects, features and advantages will become apparent to those of ordinary skill in the art from a reading of the following detailed description and the appended claims. For the avoidance of doubt, any feature of one aspect of the present invention may be utilized in any other aspect of the invention. It is noted that the examples given in the description below are intended to clarify the invention and are not intended to limit the invention to those examples per se. Other than in the experimental examples, or where otherwise indicated, all numbers expressing quantities of ingredients or reaction conditions used herein are to be understood as modified in all instances by the term “about”. Similarly, all percentages are weight/weight percentages of the total composition unless otherwise indicated. Numerical ranges expressed in the format “from x to y” are understood to include x and y. When for a specific feature multiple preferred ranges are described in the format “from x to y”, it is understood that all ranges combining the different endpoints are also contemplated. Where the term “comprising” is used in the specification or claims, it is not intended to exclude any terms, steps or features not specifically recited. All temperatures are in degrees Celsius (° C.) unless specified otherwise. All measurements are in SI units unless specified otherwise. All documents cited are—in relevant part—incorporated herein by reference.

### BRIEF DESCRIPTION OF THE FIGURES

FIG. 1 shows main interface of an Excel® Based Questionnaire Creation Wizard.

FIG. 2 is a screen capture of a general header information section of questionnaire creation tool.

FIG. 3 shows a portion of general header form showing local and network path specified for direct data entry.

FIG. 4 is a questionnaire creation wizard instruction entry form.

FIG. 5 is an example of a Participant Information Screen of Questionnaire Creation Wizard.

FIG. 6 shows a Section and Questions Screen.

FIG. 7 is Question Creation Screen with radio button controls formatted.

FIG. 8 shows steps involved in questionnaire deployment and collection of response data via e-mail.

FIG. 9 shows steps involved in questionnaire deployment as collection of response via direct data entry.

### DETAILED DESCRIPTION OF THE INVENTION

The invention relates to a spreadsheet based questionnaire creation and data collection tool that can be used by any person, trained or not in programming, to create and deploy questionnaires by e-mail or direct data entry system, and to retrieve and structure results. Since the concepts and tools are spreadsheet based, no software installation is needed. More details are noted below.

Questionnaire

One key component of the method of the invention is the creation of a respondent questionnaire using a spreadsheet application comprising a wizard utility where the wizard utility uses one or a series of macros, wherein each macro controls a series of actions.

A wizard utility is a utility within an application (e.g., spreadsheet application) that helps perform a series of tasks. Thus, for example, a “questionnaire wizard” within a spreadsheet application leads one through steps producing the final questionnaire. Macros are symbols, keys or names representing a list of commands, actions or keystrokes.

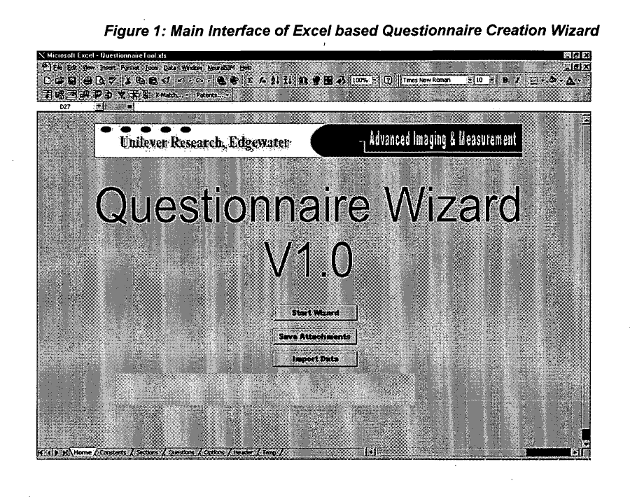

In the subject invention, as noted, the questionnaire is created from a spreadsheet wizard. One example of such spreadsheet application which can be used is Excel®. A screen capture of the main interface to the questionnaire creation wizard is shown in FIG. 1.

The questionnaire generated from the wizard can take on a variety of formats and are all HTML (Hypertext Markup Language) based. Hypertext Markup Language is coding language used to create Hypertext documents for use on the World Wide Web. HTML files are meant to be used using a World Wide Web browser program such as, for example, Netscape or Mosaic.

The questionnaire can be filled out on any personal computer equipped with, for example, browser such as Internet Explorer 5X or above and with, for example, ActiveX (code that defines Microsoft's interaction between web servers, client add ons and Microsoft Office Applications), VB scripting and Java scripting enabled. That is, the code for Activex, VB script and Java script can be read. It should be understood that the key is to use a browser which enables whatever particular script or language required to read and use the questionnaire.

The wizard provides a process to create a variety of questionnaire types that can contain several sections (e.g., header information section, instruction section, subject for collection of demographic data or other subject specific information, body of questionnaire). The body of the questionnaire may also contain multiple sections, each with a number of designed questions.

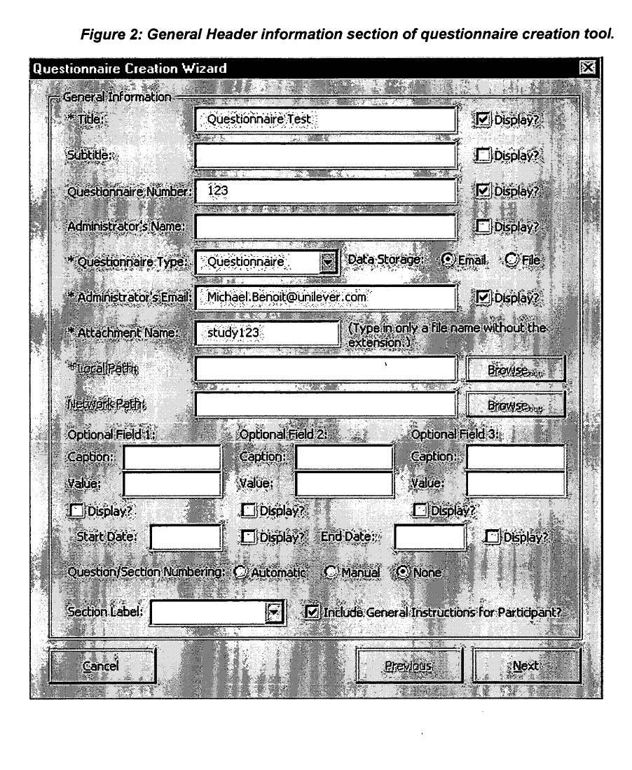

For example, upon starting the wizard, the user can be presented with a first screen that will capture general information and set up mechanics of how the questionnaire will be formed. A screen capture of such forms is seen in FIG. 2.

Those filed with an asterisk would require input, while the rest would be optional.

Fixed fields could include the questionnaire title, subtitle, number, administrator's name, attachment name (email only), local and network path (Direct data entry only), and start and, end date. In addition there is the ability to define as many optional fields as may be desired. The creator can choose to have each piece of information displayed or hidden when the questionnaire is displayed. The creator also has the option of having questions numbered automatically or manually.

In the embodiment where the questionnaire is deployed by e-mail, an attachment name must be specified. This will be the name of the questionnaire file that is attached to an email. The file will be appended with the extension .html. In this scenario, the local and network path fields are disabled.

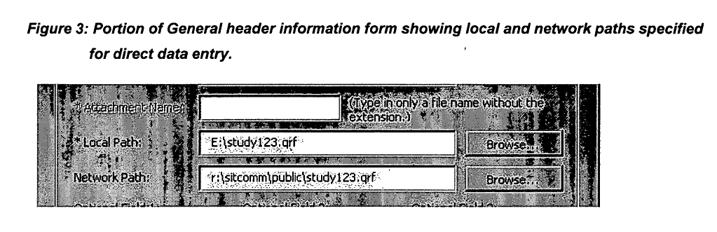

Alternatively one may choose to use the questionnaire as a direct data entry device. In this embodiment, the questionnaire would be activated on one or more computers. If the questionnaire is to be run simultaneously on more than one computer than the computers should preferably, although not necessarily, be networked so that each computer's questionnaire can write results to the specified network storage file. This scenario is ideal for situations where questionnaire respondents will be coming to a central location to fill out the questionnaire such as a clinical or consumer study run in a test center. If one wishes to use the questionnaire as a means of direct data entry than a local or network path should be given as shown in FIG. 3. Preferably, both paths should be given, although only one is required. Typically, the extension of these file names is .qrf.

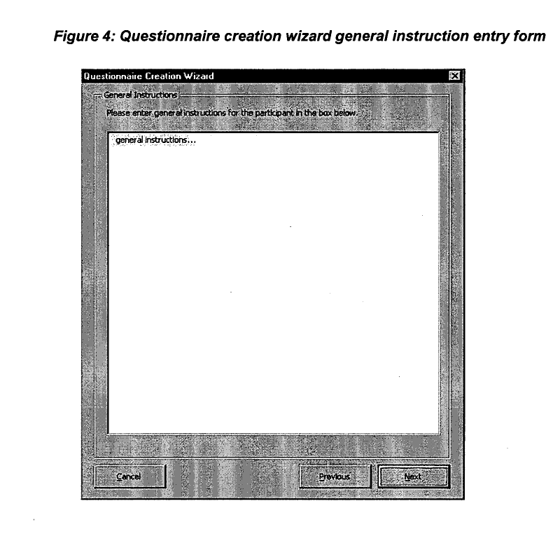

The creation tool also provides the capability of displaying a set of general instructions to the respondent prior to them beginning the questionnaire. Entering instructions is as simple as typing them into the form shown, for example, in FIG. 4.

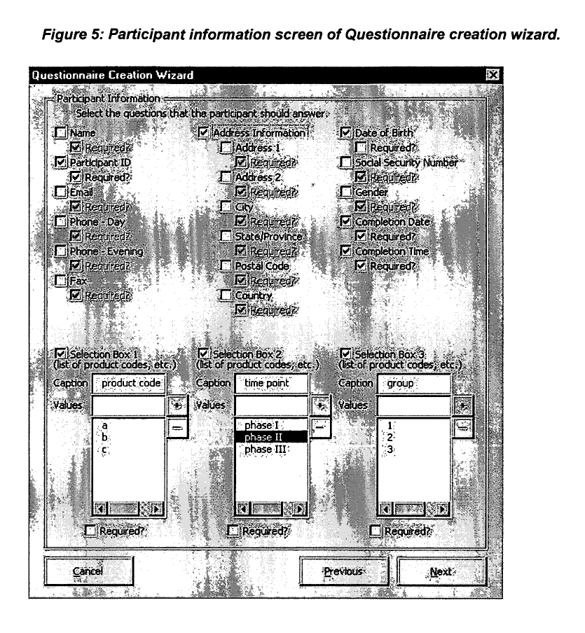

The next section of the questionnaire creation utility may provide, for example, a means of collecting panelist specific information including demographics. There may be a number of fixed fields for collecting demographic information including Names, Panelist ID's, contact information, age, and gender. In addition at least three customizable pull down lists can be create to collect additional information such as product used and time points. Any and all of these fields can be activated and they can be set individually to be required or left as optional. FIG. 5 shows an example of a participant information creation screen of the wizard.

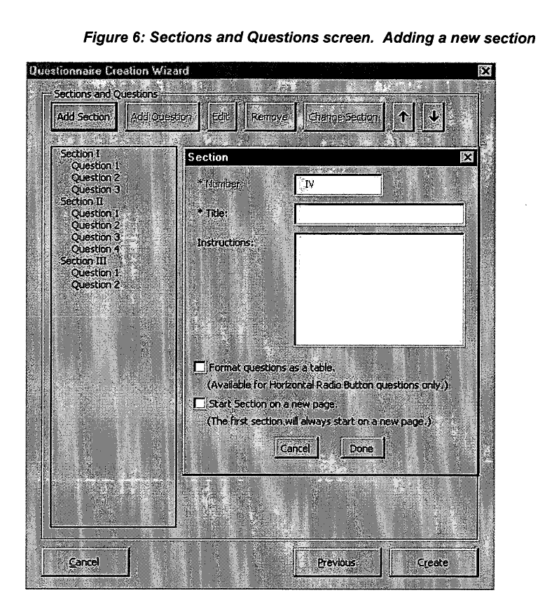

To begin creating the main body of the questionnaire, a section for this portion may be created. Sections can be used to group questions that belong together with some comments or instructions about them at the beginning of a section. FIG. 6 shows a Questionnaire body screen with several sections already created and waiting to have a new section added.

Adding a new section is as simple as specifying a title and instructions and indicating if the section is to start on a new page. It is possible to format a set of questions together in a section as a matrix format table. This is one of several question type options available.

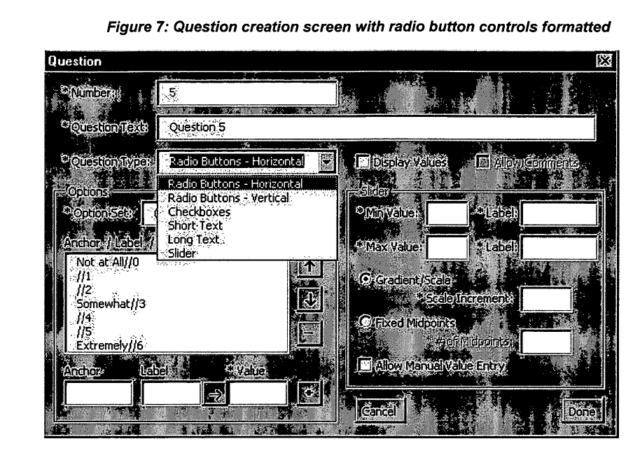

Adding new questions to a section is also a simple task. With the desired section highlighted, selecting the Add Question button will open the question creation screen as seen, for example, in FIG. 7. The new question is numbered, the text of the question is entered and, if the question has a control such as radio buttons, their labels and data values are configured. Possible question types include short and long text open ended questions, radio buttons (only 1 selection possible), check boxes (allows multiple selections), and slider bars to simulate a continuous scale. The matrix table format is really a series of radio button questions with the same value scale formatted together in a table.

To configure an open ended question all that is necessary is to select the question type and enter the question. To configure a question using radio buttons, such as a point scale, the question is entered, the question type is selected, and the radio buttons are configured by specifying the data values and optionally anchors and/or labels for any or all of the radio buttons. Once an option set is created it can be copied for use with other questions. To create a question using checkboxes the same procedure as for radio buttons is used except that the option of specifying anchors is disabled. Finally to use a slider bar the parameters in the lower right portion of the question creation screen must be defined. Allowing manual value entry for a slider bar places a test box next to the slider so that a number can be typed in. Although in the examples used, the questions in the body of the questionnaire require a response, eliminating the possibility of having skipped questions with no data, it should be understood that questions may be posed which need not be answered. Any comment fields added to a question are always optional.

The process of adding sections and questions is repeated until the questionnaire is built up. Selecting the CREATE button on the Sections and Questions screen (FIG. 6) will generate the questionnaire. This can be done at anytime in the process to preview the questionnaire during the various stages of creation.

Deploying Questionnaires and Retrieving Results

In one embodiment, the created questionnaire can be deployed by e-mail. A copy of the spreadsheet based Questionnaire Wizard, after completing the creation, must be saved in order to propertly associate the data fields with the appropriate headings or labels. Saving also allows means to go back and edit the questionnaire.

Once the questionnaire is completed, attaching it to an e-mail and sending it to desired distribution list deploys the questionnaire. Participants can fill out the questionnaire by double clicking the attachment. Once the questionnaire is completed, a response file is created and respondent is asked if they are using Microsoft® Outlook as e-mail client (i.e., computer program used to read and send e-mail supported by e-mail clients). If so, the response file is sent back to the designated administrator e-mail address embedded in the questionnaire. If Outlook® is not being used, instructions are provided to locate the response file and mail back to the designated administrator.

To tabulate the data collected, two easy steps are followed. The administrator moves all of the response emails to the local INBOX of Outlook and then clicks the Wizard button labeled “SAVE ATTACHMENTS”. It is important the version of the Spreadsheet Wizard used is the template used to create the questionnaire. The user will be prompted for a folder to store the attachments in and the utility will detach each response attachment (.qrf file) and save it in the designated folder. The next step is to click on the “IMPORT DATA” button and each response file will be read and imported into a structured Excel spreadsheet.

In a second embodiment of the invention, the questionnaire is activated on one or more computer and responses are written directly to spreadsheet, bypassing use of e-mail. A copy of Questionnaire Wizard still must be saved after completing questionnaire. As when saving copy before e-mailing, this provides a means to go back and edit, and saved template must be used to properly import resulting data into spreadsheet with appropriate headings.

In the direct data scheme, the created HTML survey is copied to the computer(s) to be used for data collection. Subjects will be seated in front of one of the computers with the questionnaire already activated. Upon completion of the questionnaire the responses are directed to up to two different files. If a local file is used, the responses on a local PC are collected on that computer and sent to the designated local file. In addition, if a central file is used or specified, the responses collected from each computer used are stored in a centrally located file that collects all of the data. Upon completion of the collection of data the master centrally stored file is easily imported into the Spreadsheet. Importing the data is done through the saved Spreadsheet template by clicking on the “Import Data” button.

Except in the operating and comparative examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

The following examples are intended to further illustrate the invention and are not intended to limit the invention in any way.

Unless indicated otherwise, all percentages are intended to be percentages by weight. Further, all ranges are to be understood to encompass both the ends of the ranges plus all numbers subsumed within the ranges.

### EXAMPLES

### Example 1

Questionnaire Wizards with screens as set forth in FIGS. 2-7 were prepared and utilized.

### Example 2

### Questionnaire Deployment and Collection of Response Data Via E-Mail

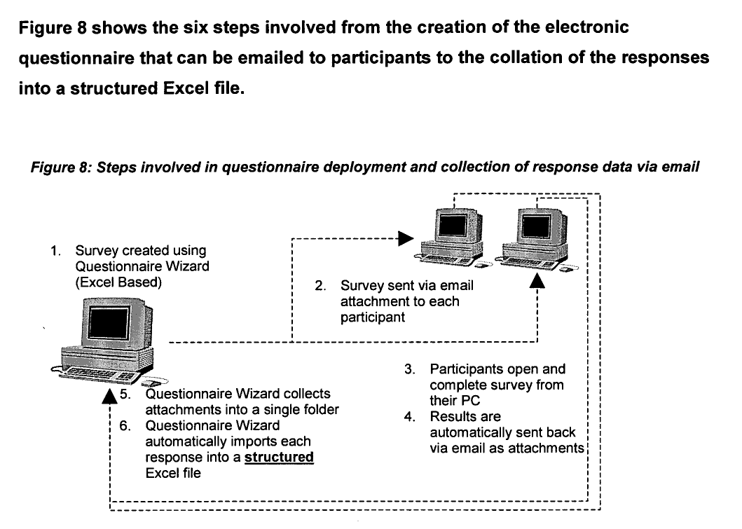

As seen in FIG. 8, in the embodiment of the invention involving deployment by e-mail, a survey was created from a spreadsheet based wizard (e.g., Excel® based spreadsheet program); the survey was sent via e-mail attachment to each participant (step 2); the respondents opened and completed the survey on their personal computer, and results were sent back via e-mail as attachments (steps 3 and 4); questionnaire wizard collected attachment into a single folder; and the wizard imported responses into a structured file (step 6).

### Example 3

### Questionnaire Deployment and Collection Via Direct Data Entry

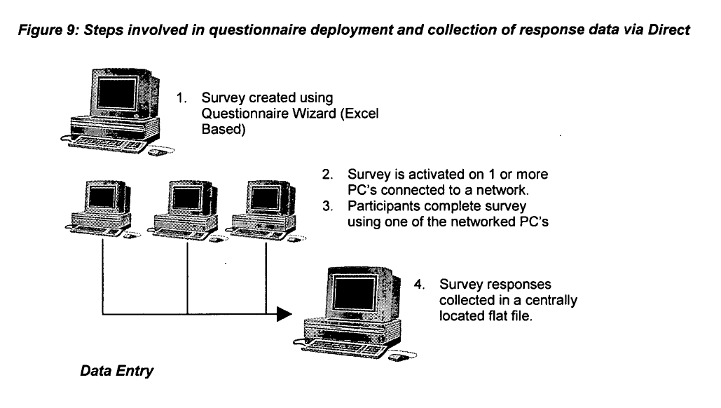

As seen in FIG. 9, direct data entry embodiment, a survey was created from a spreadsheet based wizard; the survey was activated on one or more PC connected to a network, and participants completed responses using one of the networked PCs (steps 2 and 3); and surveys were collected in a centrally located file.

1. A method of collecting data from one or multiple respondents wherein said method comprises:
(1) creating a questionnaire for respondent or respondents, wherein said questionnaire is created using a wizard utility within a spreadsheet application, which wizard operates a series of macros;
(2) deploying the questionnaire created in (1) to respondent or respondents by e-mail; and
(3) retrieving data from an e-mail attachment which is returned from respondent or respondents.

2. A method according to claim 1, wherein said deployed questionnaire is based on hypertext markup language (html) files to be used on the World Wide Web.

3. A method according to claim 2, wherein said html files are accessible by a respondent using a web browser program.

4. A method according to claim 1, wherein macros are used to create questionnaires with fixed fields and with additional optional fields.

5. A method according to claim 1, wherein, after creating the questionnaire, a copy of the questionnaire wizard is saved.

6. A method according to claim 1, wherein said questionnaire is deployed by e-mail as an attachment to the e-mail.

7. A method according to claim 6, wherein respondent accesses the questionnaire by clicking on the attachment.

8. A method according to claim 1, wherein, after deployment by the surveyor and access by respondent, the respondent fills out attached questionnaire.

9. A method according to claim 8, wherein respondent is asked if he or she is using a specified e-mail program and, if a pre-set designated e-mail program is used, the questionnaire is sent back to a designated administrator e-mail address embedded in the questionnaire.

10. A method according to claim 1, wherein all response e-mails are moved in an inbox and the wizard is used to save attachments into a designated folder.

11. A method according to claim 10, wherein attachments are imported into the spreadsheet file.

12. A method according to claim 3, wherein said browser supports ActiveX, UB script and/or Java script.
